(19) United States
(12) Patent Application Publication
(10) Pub. No.: US 2026/0119769 A1
(43) Pub. Date: Apr. 30, 2026

(54) MAGNETIC FIELD COMMUNICATION SYSTEM INCLUDING LOOP ANTENNA, AND METHOD FOR CONSTRUCTING THE SAME

(71) Applicant: ELECTRONICS AND TELECOMMUNICATIONS RESEARCH INSTITUTE, Daejeon (KR)

(72) Inventors: Jung Hoon OH, Daejeon (KR); In Kui CHO, Daejeon (KR); Jang Yeol KIM, Daejeon (KR); Kyeseok YOON, Daejeon (KR); HYUNJOON LEE, Daejeon (KR)

(73) Assignee: ELECTRONICS AND TELECOMMUNICATIONS RESEARCH INSTITUTE, Daejeon (KR)

(21) Appl. No.: 19/271,339

(22) Filed: Jul. 16, 2025

(30) Foreign Application Priority Data
Oct. 29, 2024 (KR) 10-2024-0149629

(51) Int. Cl. G06F 30/39; G06F 111/06; G06F 113/18; H01Q 7/00

(52) U.S. Cl. CPC G06F 30/39; H01Q 7/00; G06F 2111/06; G06F 2113/18

(57) ABSTRACT

A method for fabricating a magnetic field communication system is disclosed. The method comprises calculating bandwidth values based on the inductances and internal resistance values according to the number of turns of the loop antenna and a series-connected resistance included in the transmitting front end connected in series with the loop antenna, generating a valid bandwidth matrix based on whether the calculated bandwidth values satisfy the defined system requirements, generating a valid magnetic field density matrix based on whether the calculated magnetic field density values satisfy the defined system requirements including the receiver sensitivity, determining the number of turns of the loop antenna and the value of the series-connected resistance based on the valid bandwidth matrix and the valid magnetic field density matrix.

### CROSS-REFERENCE TO RELATED APPLICATIONS

This application claims priority under 35 U.S.C. § 119 to Korean Patent Application No. 10-2024-0149629 filed on Oct. 29, 2024, in the Korean Intellectual Property Office, the disclosures of which are incorporated by reference herein in their entireties.

### BACKGROUND

The present disclosure relates to a magnetic field communication system, and more particularly, to a magnetic field communication system including a loop antenna and a method of constructing the same

Magnetic field communication systems using conventional loop antennas are primarily employed for short-range communication, with Near Field Communication (NFC) technology being one of the representative examples. These systems typically operate within a range of only a few centimeters between antennas. To apply magnetic field communication to medium-to long-range distances (e.g., over 100 meters), one approach is to configure the loop antenna in a resonant form.

Loop antennas utilizing a resonance frequency can generate a high current with low output power, thereby forming a high-density magnetic field and achieving excellent power efficiency, making them suitable for wireless power transfer. However, such an approach inherently exhibits narrowband characteristics, which limit the communication bandwidth. While wide bandwidth is essential for data communication, the narrowband nature of loop antennas restricts signal transmission and hinders stable communication. Moreover, when a resonant loop antenna is used as a receiver, it provides optimal performance only at a specific frequency. In medium-to long-range communication, various environmental factors and interference may cause shifts in the resonance frequency, adversely affecting signal stability and resulting in degraded receiver sensitivity.

Due to these reasons, the design of medium-to long-range communication systems using resonant loop antennas faces practical difficulties, as it must overcome several technical challenges such as limited bandwidth availability, signal attenuation, frequency sensitivity, and the need for high output power.

### SUMMARY

To solve the above-described problems, one embodiment provides the magnetic field communication system including the loop antenna and the method of constructing the same.

According to an embodiment of the present disclosure, a method for constructing a magnetic field communication system comprising a transmitting front end, a receiving front end, and a loop antenna is disclosed. The method comprises, defining system requirements including bandwidth, communication distance, and receiver sensitivity, and determining structural and material characteristics of the loop antenna including structure, size, and coil material, calculating inductances and internal resistance values according to the number of turns of the loop antenna based on the structural and material characteristics, calculating bandwidth values according to combinations of values of a series-connected resistance and the number of turns of the loop antenna based on the internal resistance values and inductances according to the number of turns of the loop antenna, wherein the series-connected resistance is comprised in the transmitting front end and is connected in series with the loop antenna, generating a valid bandwidth matrix based on whether the calculated bandwidth values satisfy the defined system requirements, wherein the bandwidth values are calculated based on the internal resistance values and inductances according to the number of turns of the loop antenna, calculating magnetic field density values at the communication distance based on combinations of the values of the series-connected resistance and the number of turns of the loop antenna, generating a valid magnetic field density matrix based on whether the calculated magnetic field density values satisfy the defined system requirements including the receiver sensitivity, determining the number of turns of the loop antenna and a value of the series-connected resistance based on the valid bandwidth matrix and the valid magnetic field density matrix, and fabricating the loop antenna based on the determined number of turns and configuring the transmitting front end based on the determined value of the series-connected resistance.

According to an embodiment of the present disclosure, A magnetic field communication system comprises a loop antenna, a modem configured to generate a digital transmit signal, a digital-to-analog converter configured to convert the digital transmit signal to an analog transmit signal, a transmitting front end configured to deliver the analog transmit signal to the loop antenna and including a series-connected resistance connected in series with the loop antenna, a receiving front end configured to receive an analog receive signal from the loop antenna, and an analog-to-digital converter configured to convert the analog receive signal to a digital receive signal and deliver the digital receive signal to the modem. The number of turns of the loop antenna and the value of the series-connected resistance are determined based on a valid bandwidth matrix and a valid magnetic field density matrix. The valid bandwidth matrix is generated based on whether bandwidth values calculated from inductances and internal resistance values according to the number of turns of the loop antenna satisfy defined system requirements. The valid magnetic field density matrix is generated based on whether magnetic field density values at communication distance calculated according to combinations of the series-connected resistance and the number of turns of the loop antenna satisfy the defined system requirements including receiver sensitivity.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a magnetic field-based communication system according to an embodiment of the present disclosure.

FIG. 2 is a diagram illustrating a loop antenna according to an embodiment of the present disclosure.

FIG. 3 is a table showing bandwidth values calculated based on combinations of the series-connected resistance value and the number of turns of the loop antenna according to an embodiment of the present disclosure.

FIG. 4 is a graph illustrating the inductance of different loop antennas with varying numbers of turns at different frequencies according to an embodiment of the present disclosure.

FIG. 5 is a table showing bandwidth values calculated based on combinations of the series-connected resistance value and the number of turns of the loop antenna according to an embodiment of the present disclosure.

FIG. 6 illustrates a result matrix obtained by multiplying the effective bandwidth matrix and the effective magnetic field density matrix.

FIG. 7 is a flowchart illustrating a method of constructing a magnetic field communication system including a loop antenna according to an embodiment of the present disclosure.

FIG. 8 is a flowchart illustrating a method of constructing a magnetic field communication system including a loop antenna according to an embodiment of the present disclosure.

FIG. 9 is a flowchart specifically illustrating step S820 of FIG. 8 according to an embodiment of the present disclosure.

FIG. 10 is a flowchart specifically illustrating step S830 of FIG. 8 according to an embodiment of the present disclosure.

FIG. 11 is a flowchart specifically illustrating step S850 of FIG. 8 according to an embodiment of the present disclosure.

FIG. 12 is a flowchart illustrating a method of constructing a magnetic field communication system including a loop antenna according to an embodiment of the present disclosure.

### DETAILED DESCRIPTION

Hereinafter, embodiments of the present disclosure will be described clearly and in detail so that those of ordinary skill in the art may readily implement the invention.

The terms such as “unit,” “module,” and the like used herein, as well as functional blocks illustrated in the drawings, may be implemented in the form of software configurations, hardware configurations, or a combination thereof. In the following description, redundant or well-known components are omitted for clarity and to avoid obscuring the essence of the invention.

As used herein, expressions such as “A or B,” “at least one of A and B,” “at least one of A or B,” “A, B, or C,” “at least one of A, B, and C,” and “at least one of A, B, or C” are intended to include any one of the listed elements or any combination thereof.

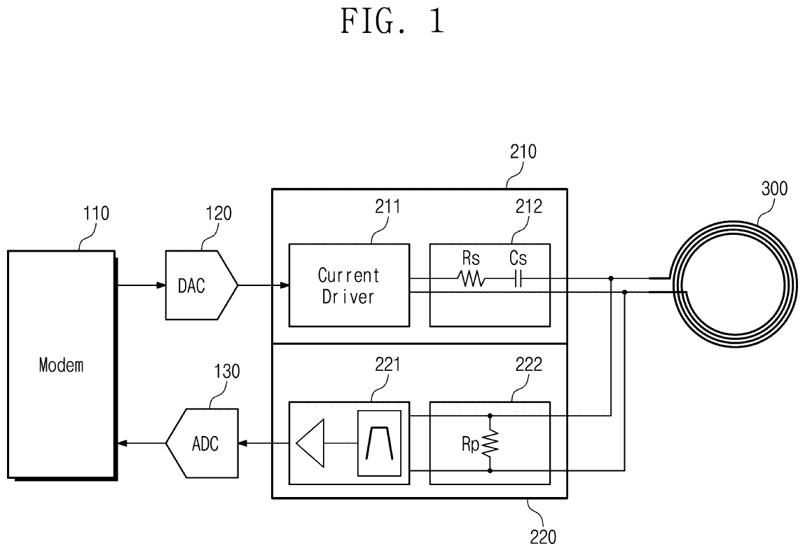

FIG. 1 is a block diagram illustrating a magnetic field-based communication system according to an embodiment of the present disclosure. The magnetic field communication system of FIG. 1 may include a modem 110, a digital-to-analog converter (DAC) 120, an analog-to-digital converter (ADC) 130, a transmitting front end 210, a receiving front end 220, and a loop antenna 300.

The modem 110 may generate a digital transmit signal. A signal to be transmitted by the magnetic field communication system may be generated in digital form by the modem 110, and for this purpose, the modem 110 may include a processor. The modem 110 may also process a signal received by the magnetic field communication system through the loop antenna 300. The received signal may be received in analog form via the loop antenna 300, converted into digital form, and then received and processed by the modem 110. In other words, the modem 110 may receive and process a digital receive signal.

The digital-to-analog converter 120 and the analog-to-digital converter 130 are devices for converting between digital and analog signals. The digital-to-analog converter 120 may convert the digital transmit signal output from the modem 110 into an analog transmit signal. The analog transmit signal output from the digital-to-analog converter 120 may be delivered to a transmitting front end 210. The analog-to-digital converter 130 may convert the analog receive signal received from a receiving front end 220 into a digital receive signal, and deliver the digital receive signal to the modem 110.

The transmitting front end 210 may deliver the analog transmit signal to the loop antenna 300. The transmitting front end 210 may include a series-connected resistance Rs connected in series with the loop antenna 300. Additionally, the transmitting front end 210 may further include a series-connected capacitor Cs connected in series with the series-connected resistance Rs. The series-connected resistance Rs and the series-connected capacitor Cs may form a matching circuit 212. The transmitting front end 210 may further include a current driver 211, which may convert a voltage signal into a current signal (i.e., the analog transmit signal), and/or amplify the analog transmit signal. The receiving front end 220 may receive the analog receive signal from the loop antenna 300. The receiving front end 220 may include a parallel-connected resistance Rp 222 connected in parallel with the loop antenna 300.

The loop antenna 300 may receive a signal generated by the transmitter (i.e., the transmitting front end 210) via the DAC 120 and the modem 110, and may radiate the signal through resonance caused by the capacitor Cs and the series resistance Rs. For example, the loop antenna 300 may transmit the signal to the outside of the system via magnetic field radiation.

In the receiver (i.e., the receiving front end 220), the magnetic field sensed by the loop antenna 300 is converted into current. Even if the receive signal does not match the transmit carrier frequency f0, it may still be converted into a voltage signal via a current signal passing through the parallel resistance Rp 222. Reference number 221 in FIG. 1 denotes a low noise amplifier (LNA) and a filter. The low noise amplifier (LNA) may amplify the voltage signal to match the input range of the ADC 130 and allow the signal to be demodulated via the modem 110.

As the value of the series-connected resistance Rs increases, the bandwidth can be extended. However, transmission efficiency may degrade due to the increased resistance. In order to achieve maximum efficiency while satisfying the required medium-range communication and system bandwidth, the following describes in detail the design steps of the loop antenna 300 and the matching circuit 212.

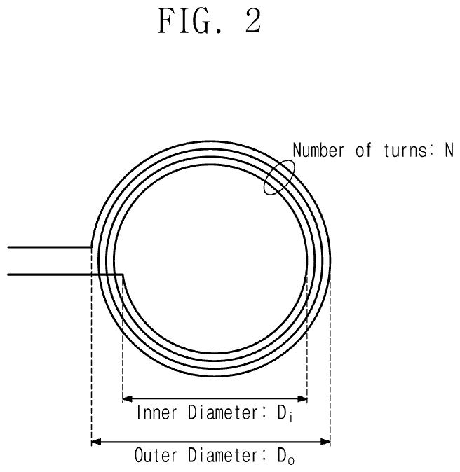

FIG. 2 illustrates a loop antenna according to an embodiment of the present disclosure. The loop antenna for the magnetic field communication system of the present disclosure is not limited to FIG. 1 and FIG. 2 and may be designed in various shapes, sizes, and numbers of turns N. FIG. 2 shows an exemplary loop antenna. The loop antenna of FIG. 2 may correspond to the loop antenna 300 in FIG. 1.

The loop antenna of FIG. 2 represents an example of a planar spiral coil. Based on the number of turns N, the inductance L, quality factor Q, and internal resistance R_internal of the antenna may be calculated. In FIG. 2, N represents the number of turns, Di may represent the innermost diameter (inner diameter) of the loop antenna, and Do may represent the outermost diameter (outer diameter) of the loop antenna.

For example, for a planar spiral loop antenna with an inner diameter of 600 mm and an outer diameter of 900 mm, a coil having an internal resistance of 2.23 Ohm per 1000 feet may be used. The inductance L may be calculated using Equation 1 below for N=5, 10, 15, 20, 25, 30, 35, and 40.

$$L = \frac{{N}^{2} \cdot {μ}_{0} \cdot {r}^{2}}{8 r + 11 d} \qquad [ Equation 1 ]$$

As an example for Equation 1, μ₀ denotes the permeability of free space (μ₀=4π×10⁻⁷ H/m), r may be approximated as an average value of the inner and outer diameters of the coil forming the loop antenna, i.e., (inner diameter+outer diameter of the coil)/2, the total length d of the coil may be calculated as the product of the number of turns N and the circumference 2πr (i.e., d=N×2πr).

Table 1 below shows the inductance L and internal resistance R_internal values according to the number of turns N of the loop antenna. The thickness W of the coil may be 3 mm, and since the given number of turns must be accommodated between the inner and outer diameters of the loop antenna, the spacing between the coils may vary depending on the number of turns. Table 1 is prepared based on values calculated using Equation 1, assuming r=750 mm.

TABLE 1

| N | W (mm) | Spacing (mm) | L (μH) | R_internal (mΩ) |
|---|---|---|---|---|
| 5 | 3 | 27 | 36 | 86 |
| 10 | 3 | 12 | 144 | 172 |
| 15 | 3 | 7 | 323 | 258 |
| 20 | 3 | 4.5 | 575 | 344 |
| 25 | 3 | 3 | 898 | 430 |
| 30 | 3 | 2 | 1293 | 516 |
| 35 | 3 | 1.3 | 1758 | 602 |
| 40 | 3 | 0.8 | 2290 | 688 |

In order for each loop antenna with a given number of turns to resonate at a resonance frequency (e.g., 20 kHz), the capacitance of the series-connected capacitor Cs may be derived using Equation 2 and 3. The quality factor Q and the bandwidth BW may be calculated using Equations 4 and 5, respectively. Table 2 below shows the results of these calculations.

$$f = \frac{1}{2 π \sqrt{LC}} \qquad [ Equation 2 ]$$

$$C = \frac{1}{{( 2 π f )}^{2} \cdot L} \qquad [ Equation 3 ]$$

$$Q = \frac{1}{R} \sqrt{\frac{L}{C}} \qquad [ Equation 4 ]$$

$$BW = \frac{f}{Q} \qquad [ Equation 5 ]$$

The following Table 2 is a table showing the capacitance values of the capacitor Cs and the calculated bandwidth BW at resonance according to the number of turns of the loop antenna for resonance at 20 kHz. Table 2 is provided as an example for a case in which the resonance frequency is 20 kHz.

TABLE 2

| N | C (nF) | Q | BW (Hz) |
|---|---|---|---|
| 5 | 1764 | 52 | 381 |
| 10 | 441 | 105 | 191 |
| 15 | 196 | 157 | 127 |
| 20 | 110 | 210 | 95 |
| 25 | 71 | 262 | 76 |
| 30 | 49 | 315 | 64 |
| 35 | 36 | 367 | 55 |
| 40 | 28 | 418 | 48 |

In one example, if the system requirement specifies a bandwidth of 200 Hz, then in order to implement a magnetic field communication system with a bandwidth of 200 Hz or greater, the only number of turns N of the loop antenna that satisfies the requirement, using only the internal resistance of the pure loop coil as shown in Table 2, is N=5.

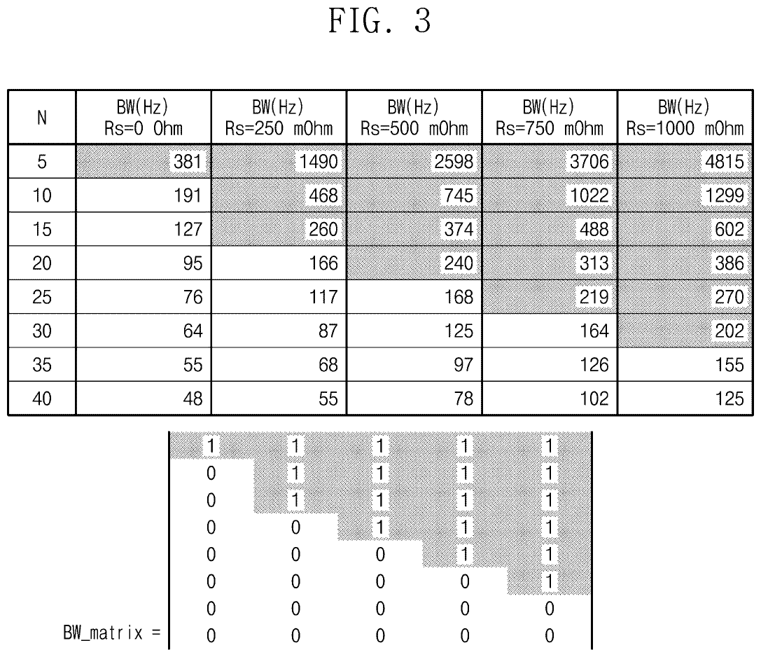

FIG. 3 shows a table of calculated bandwidth values according to the combination of the series-connected resistance and the number of turns of the loop antenna, and a valid bandwidth matrix BW_matrix, in accordance with an embodiment of the present disclosure. The matrix in FIG. 3 is the valid bandwidth matrix BW_matrix, and the table in FIG. 3 can be used to construct the valid bandwidth matrix BW_matrix.

According to an example of constructing the valid bandwidth matrix BW_matrix based on the table in FIG. 3, if a first bandwidth value (e.g., 381 Hz) at a first position in the table (e.g., row 1, column 1) satisfies the defined system requirement (e.g., greater than 200 Hz), the corresponding element in the valid bandwidth matrix (e.g., row 1, column 1) is set to 1. Conversely, if a second bandwidth value (e.g., 191 Hz) at a second position in the table (e.g., row 2, column 1) does not satisfy the defined system requirement (e.g., less than 200 Hz), the corresponding element in the valid bandwidth matrix (e.g., row 2, column 1) is set to 0.

To satisfy the required bandwidth with antennas of various turn counts, the resistor (series-connected resistor Rs) can be additionally connected in series with the loop antenna and the series-connected capacitor (Cs), thereby reducing the quality factor (Q) and increasing the bandwidth. In this case, the R in Equation 4 becomes R_total=R_internal+Rs (i.e., the sum of the internal resistance and the series-connected resistor), and the bandwidth can be calculated using Equation 5. The calculation results are shown in the table of FIG. 3, and the valid bandwidth matrix BW_matrix can be constructed by setting a value of 1 when the bandwidth requirement is satisfied, or 0 when it is not. The shaded items in the table and matrix of FIG. 3 may indicate that the corresponding configurations meet the defined system requirements.

To determine the value of the series-connected resistor Rs of the transmitting front end 210 in the magnetic field communication system, it is necessary to verify whether the minimum Rs value required for each turn count satisfies the defined system bandwidth requirement, since adding the series-connected resistor Rs reduces transmission efficiency. According to the table in FIG. 3, to ensure a bandwidth of 200 Hz, the maximum number of turns is N=30, and in this case, Rs=1 Ohm.

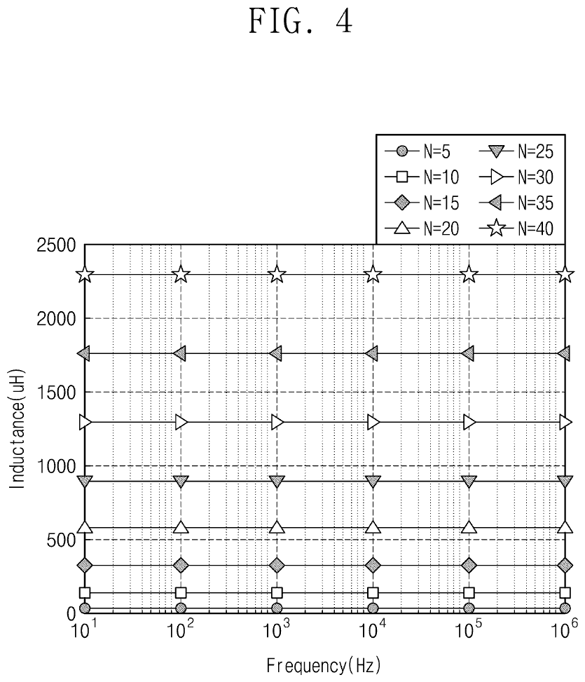

FIG. 4 is a graph illustrating the inductance of different loop antennas with varying numbers of turns at different frequencies according to an embodiment of the present disclosure.

During transmission, increasing the voltage of the loop antenna increases the magnetic field density at a mid-range distance. Accordingly, the receiver sensitivity can be lower, reducing the burden on the receiver, but increasing the burden on the transmitter. Conversely, lowering the transmit voltage of the transmitter reduces the transmitter's burden, but requires higher receiver sensitivity. Therefore, the transmit voltage of the transmitter and the sensitivity of the receiver must be balanced through a trade-off in accordance with the system requirements.

Additionally, if the loop antenna 300 (of FIG. 1) resonates with the receiving RF front end 220 (of FIG. 1), a narrowband response is determined. In such cases, if an error occurs in the receive resonant frequency due to environmental factors or interference, reception may become impossible. As shown in FIG. 4, if the self-inductance remains constant despite frequency changes of each loop antenna, the current induced in the coil remains constant with frequency, and the voltage across the parallel resistor Rp also remains constant. As a result, reception can occur regardless of frequency variation caused by environmental factors or interference.

Assuming a receiver with a minimum detectable magnetic field density of 20 pT located 100 m away from the center of the loop antenna 300 (or the loop antenna of FIG. 2), the current flowing through the loop antenna 300 can be calculated using Equations 6 and 7, which describe the relationship between the magnetic field density B detected by the loop antenna 300 and the corresponding current I. Equation 7 may be derived from Equation 6. In Equations 6 and 7, B is the magnetic field density (e.g., 20 pT=20×10⁻¹² T considering the system-defined receiver sensitivity), po is the permeability of free space, N is the number of turns (i.e., coil turns) of the loop antenna, I is the current flowing through the loop antenna, and R is the radius of the loop antenna.

$$B = \frac{{μ}_{0} \cdot N \cdot I}{2 \cdot R} \qquad [ Equation 6 ]$$

$$I = \frac{2 \cdot B \cdot R}{{μ}_{0} \cdot N} \qquad [ Equation 7 ]$$

The following Table 3 includes the results of calculating the current values induced by the magnetic field sensed by the loop antenna for each number of turns N, assuming that the magnetic field density corresponding to the defined system requirement for receiver sensitivity is 20 pT. Additionally, Table 3 includes the results of calculating the values of the parallel-connected resistance (Rp; 222) required for the low noise amplifier (LNA) input to reach 1 V, based on the current values for each number of turns. As shown in Table 3, in order to convert current in the microampere (μA) range into a 1 V LNA input voltage, the value of the parallel-connected resistance (Rp) can be selected in the range of approximately 400 kΩ to 3 MΩ depending on the number of turns.

TABLE 3

| N | Current (μA) | Resistance (kΩ) |
|---|---|---|
| 5 | 2.3873 | 418.88 |
| 10 | 1.1937 | 837.76 |
| 15 | 0.79577 | 1256.6 |
| 20 | 0.59683 | 1675.5 |
| 25 | 0.47746 | 2094.4 |
| 30 | 0.39789 | 2513.3 |
| 35 | 0.34105 | 2932.2 |
| 40 | 0.29842 | 3351 |

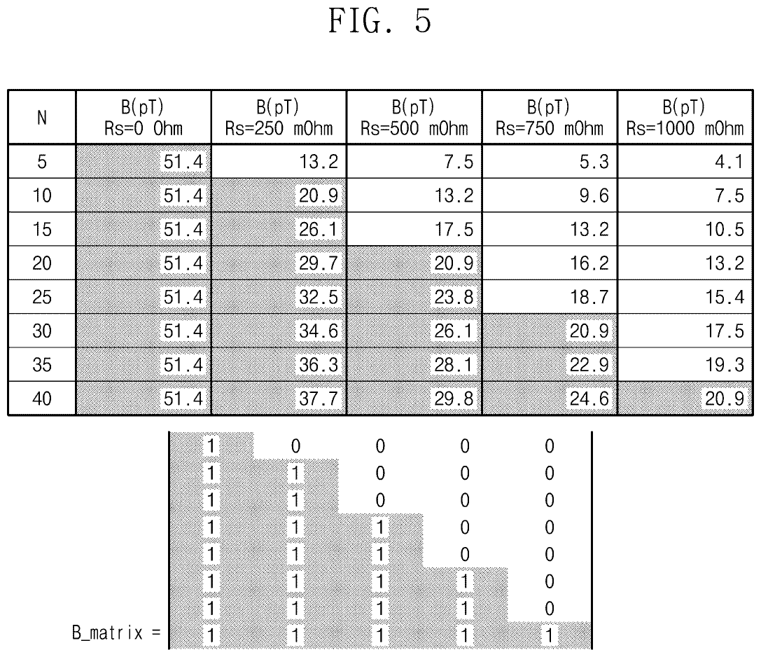

FIG. 5 illustrates a table showing bandwidth values calculated according to combinations of the series-connected resistance value and the number of turns of the loop antenna, and a valid magnetic field density matrix B_matrix, according to an embodiment of the present disclosure. Referring to FIG. 5, a procedure for calculating the magnetic field density that meets the requirements at the transmission distance is described. The magnetic field density at a location that is a distance R away from the center of the loop antenna may be calculated based on Equation 8 below.

$$B = N \frac{{μ}_{0} \cdot I \cdot {r}^{2}}{2 {( {R}^{2} + {r}^{2} )}^{3 / 2}} \qquad [ Equation 8 ]$$

In Equation 8, μ₀ denotes the permeability of free space (μ₀=4π×10⁻⁷ H/m), N is the number of turns (i.e., the number of coil windings) of the loop antenna, I is the current flowing through the loop antenna, r is the radius of the loop antenna (e.g., 0.375 m), and R is the distance from the center of the loop antenna (e.g., 100 m). Referring to Equation 8, the electric field is inversely proportional to the square of the distance R, whereas the magnetic field is inversely proportional to the cube of the distance R. Therefore, the decrease in field strength with distance is more severe for the magnetic field than for the electric field.

In one example, when a transmit voltage of 1 V is applied to the loop antenna at the transmitter, and the receiver is assumed to have a minimum detectable magnetic field density of 20 pT at a distance of 100 m from the center of the loop antenna, the magnetic field density at 100 m can be calculated using Equation 8. The calculation results are shown in the table of FIG. 5. Based on whether the calculated magnetic field density satisfies the receiver's minimum sensitivity requirement of 20 pT or more, a valid magnetic field density matrix (B matrix) can be constructed by assigning a value of 1 if the requirement is met, or 0 if not.

In other words, according to an example of constructing the valid magnetic field density matrix (B matrix) based on the table in FIG. 5, if a first magnetic field density value (e.g., 51.4 pT) at a third position in the table (e.g., row 2, column 1) satisfies the defined system requirement (i.e., greater than 20 pT), the element at the third position (e.g., row 2, column 1) of the B matrix is assigned a value of 1. Conversely, if a second magnetic field density value (e.g., 13.2 pT) at a fourth position in the table (e.g., row 2, column 3) does not meet the defined system requirement (i.e., less than 20 pT), the element at the corresponding position (e.g., row 2, column 3) of the B matrix is assigned a value of 0.

The number of rows in the table of FIG. 5 may be the same as the number of rows in the table of FIG. 3, and the number of columns in the table of FIG. 5 may also be the same as the number of columns in the table of FIG. 3. In addition, the number of rows in the effective bandwidth matrix BW_matrix of FIG. 3 may be the same as the number of rows in the effective magnetic field density matrix B_matrix of FIG. 5, and the number of columns in the effective bandwidth matrix BW_matrix of FIG. 3 may also be the same as the number of columns in the effective magnetic field density matrix B_matrix of FIG. 5. That is, the size of the table of FIG. 5 may be the same as the size of the table of FIG. 3, and the size of the effective bandwidth matrix BW_matrix of FIG. 3 may be the same as the size of the effective magnetic field density matrix B_matrix of FIG. 5.

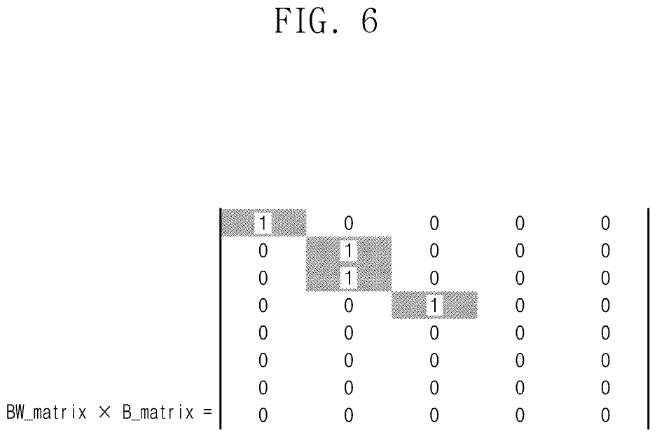

FIG. 6 illustrates a result matrix obtained by multiplying the effective bandwidth matrix and the effective magnetic field density matrix. FIG. 6 may be described in conjunction with FIG. 1 to FIG. 5.

The number of turns N and the value of the series-connected resistance Rs may be determined based on a position (for example, row 1, column 1 in FIG. 6) of an element having a value of 1 in the multiplication result matrix of the effective bandwidth matrix BW_matrix and the effective magnetic field density matrix B_matrix. The determined values N and Rs correspond to the position (row 1, column 1). The magnetic field communication system may be constructed by fabricating the loop antenna 300 and configuring the transmitting front end 210 based on the determined values N and Rs.

For example, since the value of the element in row 1, column 1 of the matrix in FIG. 6 is 1, the corresponding values of Rs=0 Ohm and N=5 in row 1, column 1 of the tables in FIG. 3 and FIG. 5 may be selected for constructing a magnetic field communication system including the loop antenna. In one example, if there are two or more elements with a value of 1 in the result matrix obtained by multiplying the effective bandwidth matrix BW_matrix and the effective magnetic field density matrix B_matrix, the case with the smallest Rs value may be selected. If Rs values are equal, the case with the smallest N may be selected. However, the embodiments of the present disclosure are not necessarily limited to such examples.

Referring to FIG. 6, based on the multiplication result matrix of the effective bandwidth matrix BW_matrix of FIG. 3 and the effective magnetic field density matrix B_matrix of FIG. 5, combinations such as (N=5, Rs=0 Ohm), (N=10, Rs=250 mOhm), (N=15, Rs=250 mOhm), and (N=20, Rs=500 mOhm) may be selected as the number of turns N and the series-connected resistance Rs for constructing the magnetic field communication system including the loop antenna.

The number of rows in the result matrix obtained by multiplying the effective bandwidth matrix BW_matrix and the effective magnetic field density matrix B_matrix in FIG. 6 may be the same as the number of rows in the effective bandwidth matrix BW_matrix of FIG. 3 and the effective magnetic field density matrix B_matrix of FIG. 5. Likewise, the number of columns in the multiplication result matrix may be the same as the number of columns in the matrices of FIG. 3 and FIG. 5. That is, the size of the multiplication result matrix in FIG. 6 may be the same as the size of the tables in FIG. 3 and FIG. 5, as well as the size of the effective bandwidth matrix BW_matrix and the effective magnetic field density matrix B_matrix.

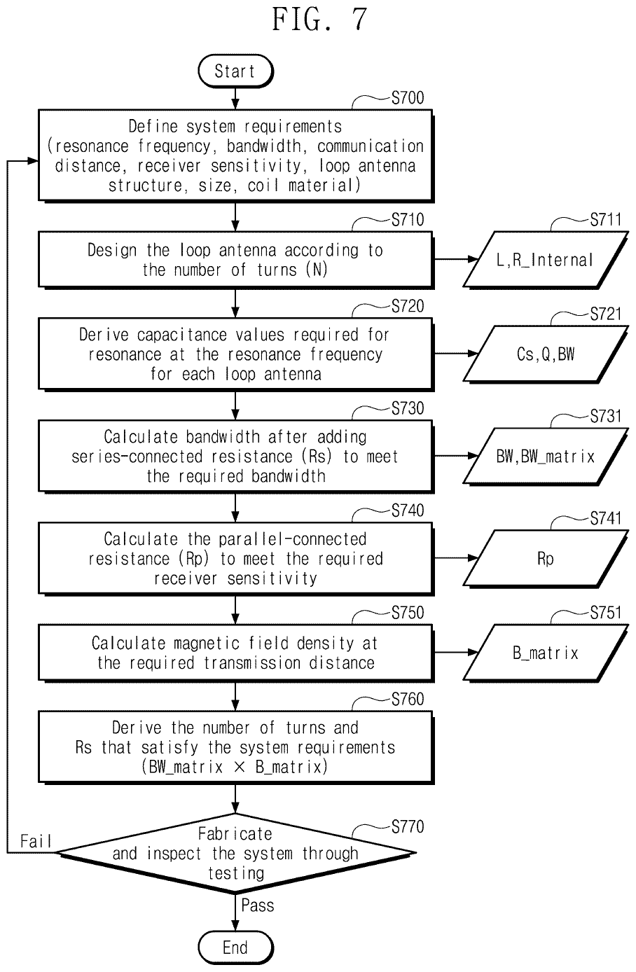

FIG. 7 is a flowchart illustrating a method of constructing a magnetic field communication system including a loop antenna according to an embodiment of the present disclosure. FIG. 7 may be described in conjunction with FIG. 1 to FIG. 6.

The method of FIG. 7 may include a step of designing a loop antenna 300 and a matching circuit 212 for the magnetic field communication system. According to conventional design methods, increasing the value of the series-connected resistor Rs in the transmitting radio frequency (RF) front end 210 provides a bandwidth expansion effect, but it results in reduced transmission efficiency due to the increased resistance. The method of FIG. 7 may be implemented to achieve maximum efficiency while satisfying the required mid-range communication and system bandwidth.

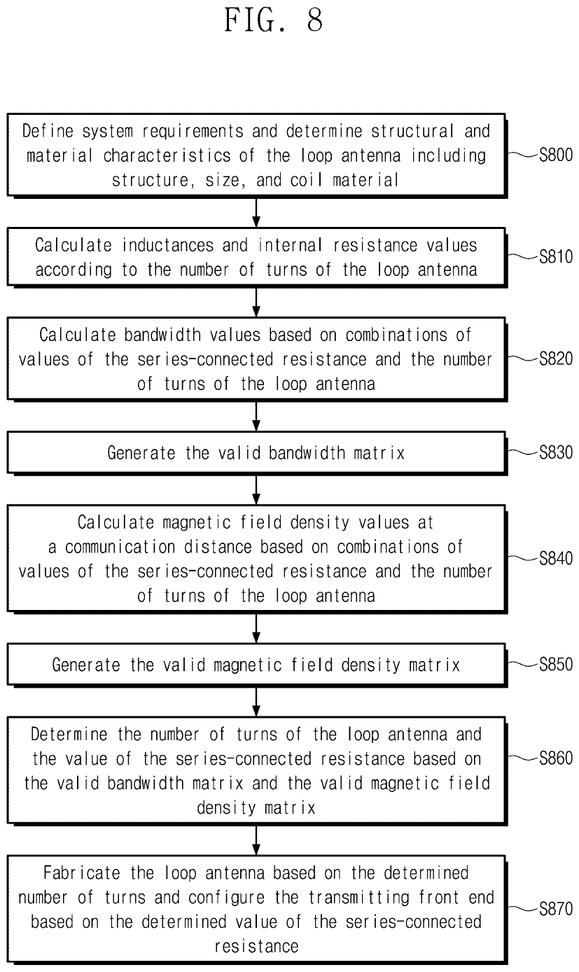

Through the method of FIG. 7, the loop antenna may be fabricated, and a system such as that shown in FIG. 1 may be constructed, followed by a verification process through actual testing. It may then be determined whether the system meets the system requirements. If not, the system requirements may be reviewed and revised. Each step of FIG. 7 corresponds to the steps of FIG. 8, and the steps of FIG. 7 may be described in conjunction with FIG. 8.

FIG. 8 is a flowchart illustrating a method of constructing a magnetic field communication system including a loop antenna according to an embodiment of the present disclosure. FIG. 8 may be described in conjunction with FIG. 1 to FIG. 7.

In step S800, system requirements including bandwidth, communication distance, and receiver sensitivity may be defined for constructing the magnetic field communication system. In addition, structural and material characteristics of the loop antenna, including structure, size, and coil material, may be determined. This step may correspond to step S700 of FIG. 7.

In step S810, based on the structural and material characteristics of the loop antenna 300, the inductance and internal resistance values according to the number of turns of the loop antenna 300 may be calculated. This corresponds to steps S710 and S711 of FIG. 7.

In step S820, based on the inductance L and internal resistance R_Internal values according to the number of turns N of the loop antenna 300, the bandwidth BW values for combinations of the number of turns N and the value of the series-connected resistor Rs may be calculated. This corresponds to step S730 of FIG. 7.

In step S830, based on the determination of whether the calculated bandwidth BW values based on the inductance L and internal resistance R_Internal according to the number of turns N of the loop antenna 300 satisfy the defined system requirements, the valid bandwidth matrix BW_matrix may be constructed. This corresponds to step S731 of FIG. 7.

In step S840, magnetic field density B values at the communication distance may be calculated for combinations of the number of turns N of the loop antenna 300 and the value of the series-connected resistor Rs. This corresponds to step S750 of FIG. 7.

In step S850, based on the determination of whether the calculated magnetic field density B values satisfy the defined system requirements including receiver sensitivity, the valid magnetic field density matrix B_matrix may be constructed. This corresponds to step S751 of FIG. 7.

In step S860, based on the valid bandwidth matrix BW_matrix and the valid magnetic field density matrix B_matrix, the number of turns N of the loop antenna 300 and the value of the series-connected resistor Rs may be determined. This corresponds to step S760 of FIG. 7.

In step S870, based on the determined number of turns N, the loop antenna 300 may be fabricated, and based on the determined value of the series-connected resistor Rs, the transmitting front end 210 may be configured. This corresponds to step S770 of FIG. 7.

The method of FIG. 8 may further include a step of testing the constructed (fabricated) communication system and verifying whether it satisfies the defined system requirements for resonant frequency, bandwidth, communication distance, and receiver sensitivity. This step may correspond to step S770 of FIG. 7.

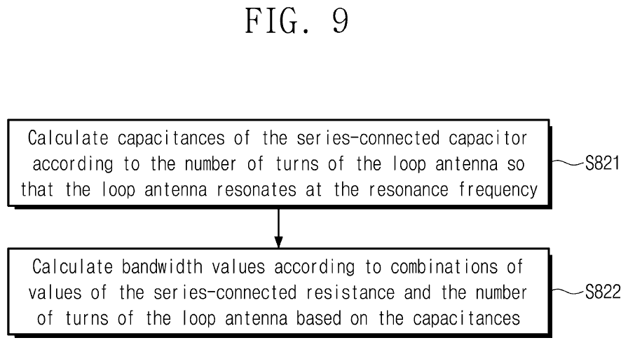

FIG. 9 is a flowchart for specifically explaining step S820 of FIG. 8 according to an embodiment of the present disclosure. FIG. 9 may be described in conjunction with FIG. 1 to FIG. 8. As described above, the defined system requirements may include a resonant frequency, and the transmitting front end 210 may include a series-connected capacitor Cs connected in series with a series-connected resistor Rs. That is, the system requirements may include criteria for the resonant frequency at which the magnetic field communication system operates.

In step S821, capacitance values of the series-connected capacitor Cs for allowing the loop antenna 300 to resonate at the resonant frequency may be calculated based on the number of turns of the loop antenna. For example, as shown in Table 2, when the number of turns N is 5, 10, 15, 20, 25, 30, 35, or 40, capacitance values C for satisfying the resonant frequency f defined in the system requirements may be calculated based on Equation 3.

In step S822, the bandwidth BW values for combinations of the value of the series-connected resistor Rs and the number of turns N of the loop antenna 300 may be calculated based on the capacitance values calculated in step S821. For example, the bandwidth BW values may be calculated based on Equation 4 and Equation 5.

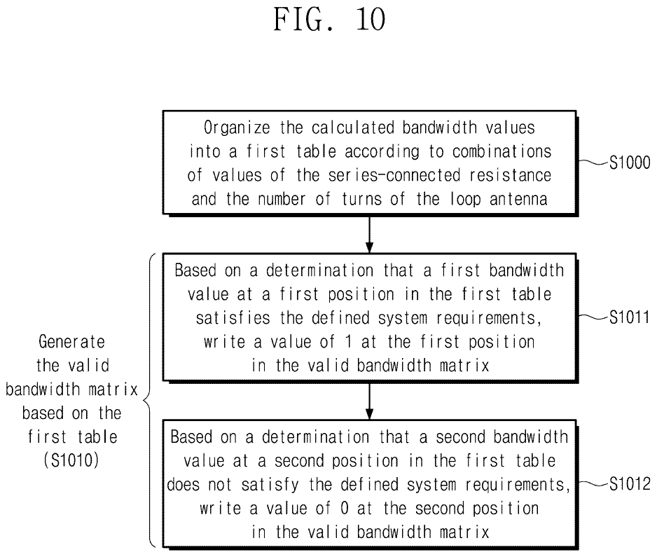

FIG. 10 is a flowchart specifically illustrating step S830 of FIG. 8 according to an embodiment of the present disclosure. FIG. 10 may be described in conjunction with FIG. 1 through FIG. 9. FIG. 10 describes a step of constructing the valid bandwidth matrix BW_matrix.

In step S1000, the calculation results of bandwidth BW values according to combinations of the value of the series-connected resistor Rs and the number of turns N of the loop antenna 300 may be organized into a first table.

In step S1010, the valid bandwidth matrix BW_matrix may be constructed based on the first table. In one example, if a first bandwidth value included in a first position of the first table is determined to satisfy the defined system requirements, the value of the element at the first position of the valid bandwidth matrix may be set to 1. Conversely, if a second bandwidth value included in a second position of the first table is determined not to satisfy the defined system requirements, the value of the element at the second position of the valid bandwidth matrix BW_matrix may be set to 0.

In one example, the determination that the first bandwidth value satisfies the defined system requirements may be based on whether the first bandwidth value is greater than or equal to the required bandwidth. Additionally, the determination that the second bandwidth value does not satisfy the defined system requirements may be based on whether the second bandwidth value is less than the required bandwidth.

In other words, after constructing the valid bandwidth matrix BW_matrix with the same size as the table of bandwidth BW values calculated for each combination of the series-connected resistor Rs value and the number of turns N of the loop antenna 300, if the first bandwidth value included in a first position (k-th row, 1-th column) of the first table is greater than or equal to the bandwidth in the system requirements, a 1 is written at the first position (k-th row, 1-th column) of the valid bandwidth matrix BW_matrix. If the second bandwidth value included in a second position (i-th row, j-th column) of the first table is less than t the bandwidth in the system requirements, a 0 is written at the second position (i-th row, j-th column) of the valid bandwidth matrix BW_matrix.

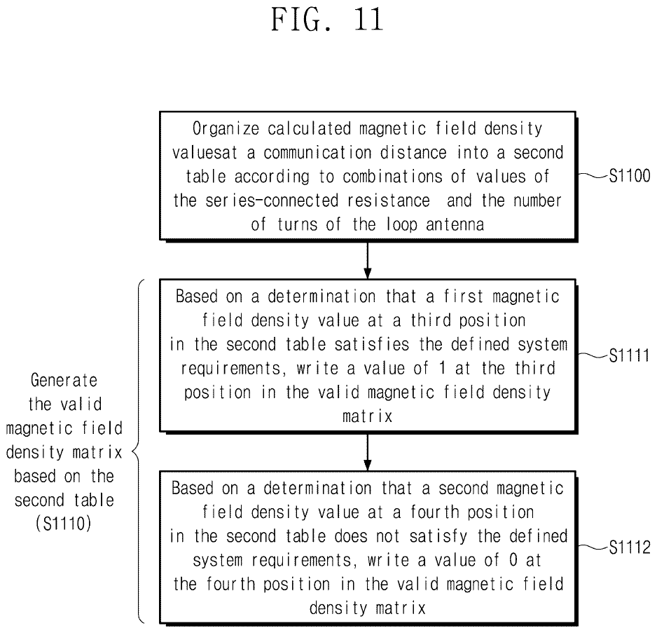

FIG. 11 is a flowchart specifically illustrating step S850 of FIG. 8 according to an embodiment of the present disclosure. FIG. 11 may be described in conjunction with FIG. 1 through FIG. 10. FIG. 11 may describe a step of constructing the valid magnetic field density matrix B_matrix.

In step S1100, the calculated results of magnetic field density B values at the communication distance based on combinations of the value of the series-connected resistor Rs and the number of turns N of the loop antenna 300 may be organized into a second table.

In step S1110, the valid magnetic field density matrix B_matrix may be constructed based on the second table. In one example, if a first magnetic field density value included in a third position of the second table is determined to satisfy the defined system requirements, the value of the element at the third position of the valid magnetic field density matrix B_matrix may be set to 1. Conversely, if a second magnetic field density value included in a fourth position of the second table is determined not to satisfy the defined system requirements, the value of the element at the fourth position of the valid magnetic field density matrix may be set to 0.

In one example, the determination that the first magnetic field density value satisfies the defined system requirements may be based on whether the first magnetic field density value is greater than or equal to the magnetic field density corresponding to the receiver sensitivity specified in the system requirements. The determination that the second magnetic field density value does not satisfy the system requirements may be based on whether the second magnetic field density value is less than the magnetic field density corresponding to the receiver sensitivity specified in the system requirements.

In other words, after constructing the valid magnetic field density matrix B_matrix having the same size as the table (second table) containing the calculation results of the magnetic field density B values according to the combination of the value of the series-connected resistor Rs and the number of turns N of the loop antenna 300 at the communication distance, if the first bandwidth value included at a first position (row k, column 1) in the first table is greater than or equal to the bandwidth defined by the system requirements, a value of 1 is written at the first position (row k, column 1) in the valid magnetic field density matrix B_matrix. If the first bandwidth value included at a second position (row i, column j) in the first table is smaller than the bandwidth defined by the system requirements, a value of 0 is written at the second position (row i, column j) in the valid magnetic field density matrix B_matrix.

Taken together, FIG. 10 and FIG. 11 show that in order to determine the number of turns N of the loop antenna 300 and the value of the series-connected resistor Rs based on the valid bandwidth matrix BW_matrix and the valid magnetic field density matrix B_matrix, one may reference the position (row m, column n) of an element with a value of 1 in the matrix resulting from multiplying BW_matrix and B_matrix. Based on this position, the corresponding values of N and Rs are selected to fabricate the loop antenna 300 and configure the transmitting front end 210, thereby constructing the magnetic field communication system.

In one example, the number of rows in the first table described with reference to FIG. 10 may be the same as the number of rows in the second table described with reference to FIG. 11, and the number of columns in the first table may also be the same as in the second table. Additionally, the number of rows and columns of the valid bandwidth matrix BW_matrix may be equal to those of the valid magnetic field density matrix B_matrix. That is, the size of the first table may match the size of the second table, and the size of the BW_matrix may match the size of the B_matrix.

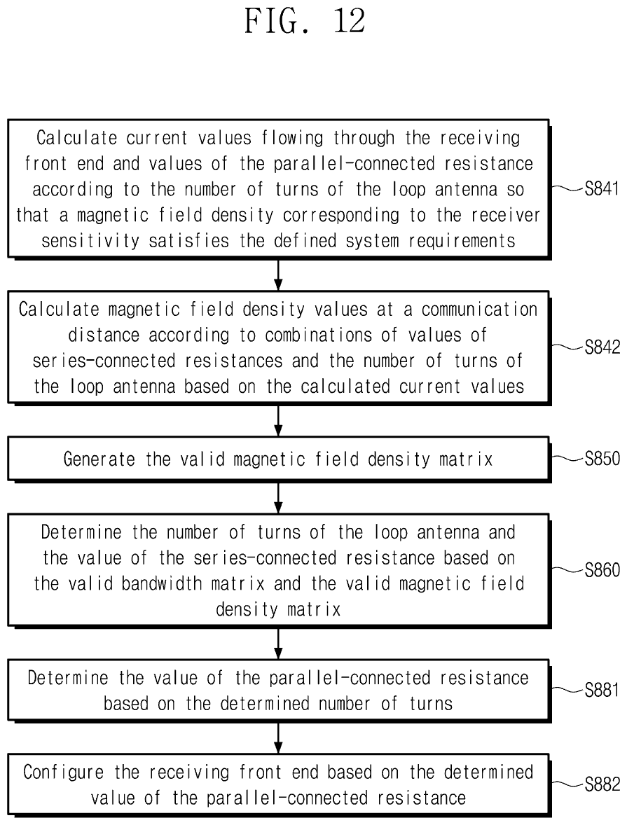

FIG. 12 is a flowchart illustrating a method of constructing a magnetic field communication system including a loop antenna according to an embodiment of the present disclosure. FIG. 12 may be described in conjunction with FIG. 1 through FIG. 11. Specifically, FIG. 12 may be described with FIG. 7 and FIG. 8, and steps already explained in FIG. 8 may be omitted from FIG. 12. FIG. 12 will be described in more detail on the assumption that the receiving front end 220 includes a parallel-connected resistor (Rp; 222) connected in parallel with the loop antenna 300.

Steps S841 and S842 of FIG. 12 may correspond to step S840 of FIG. 8. In step S841, current values flowing through the receiving front end 220 and values of the parallel-connected resistor (Rp; 222) that satisfy the magnetic field density requirement corresponding to the receive sensitivity defined in the system requirements may be calculated based on the number of turns N of the loop antenna 300. For example, as shown in Table 3, for each case where the number of turns N is 5, 10, 15, 20, 25, 30, 35, or 40, the current values required to meet the magnetic field density criterion corresponding to the receiver sensitivity defined in the system requirements may be calculated based on Equation 7, and the value of the parallel-connected resistor (Rp; 222) may be calculated such that the voltage across the low-noise amplifier (LNA) is 1V.

In step S842, magnetic field density B values at the communication distance based on the combinations of the series-connected resistance Rs and the number of turns N of the loop antenna 300 may be calculated based on the current values being calculated based on the number of turns N of the loop antenna 300. For example, the magnetic field density values in this step may be calculated based on Equation 8, and the current values calculated for each number of turns in step S841 may be used in this calculation.

In step S850, the valid magnetic field density matrix B_matrix may be constructed based on the determination of whether the magnetic field density values calculated in step S842 satisfy the system requirements including the receiver sensitivity. Step S850 may be carried out by referring to the procedures illustrated in FIG. 10.

Step S860 is included in FIG. 12 to illustrate that the valid magnetic field density matrix B_matrix being constructed based on steps S841, S842, and S850 is utilized in step S860. This step has already been described in detail with FIG. 8.

In step S881, after determining the number of turns N of the loop antenna based on the valid bandwidth matrix BW_matrix and the valid magnetic field density matrix B_matrix, the value of the parallel-connected resistor (Rp; 222) may be determined based on the determined number of turns.

In step S882, the receiving front end may be configured based on the determined value of the parallel-connected resistor (Rp; 222).

Embodiments of the present disclosure are intended to solve the problems of the conventional technologies described above, and aim to provide a magnetic field transmitting device for ensuring bandwidth and medium-range communication, and a magnetic field receiving device and method that are less sensitive to frequency and more stable.

Embodiments of the present disclosure aim to extend the communication range of magnetic field communication and achieve high-density magnetic field transmission with high efficiency. To this end, a capacitor Cs may be series-resonated with the loop antenna to maximize the efficiency of magnetic field transmission. To expand the bandwidth of a resonant loop antenna, a series-connected resistor Rs may be connected to the loop antenna. This resistor increases the limited bandwidth of the narrowband characteristics, thereby ensuring sufficient bandwidth for data transmission. Further, in receiving data using a single loop antenna, the microcurrent induced in the loop antenna may be converted into a voltage. To do so, instead of resonating the antenna, a parallel resistor Rp may be connected to the antenna, and the voltage difference across the resistor may be measured regardless of frequency errors caused by environmental factors and interference. This voltage difference may be amplified via a low-noise amplifier (LNA) and stably obtained as a received signal.

Specifically, embodiments of the present disclosure allow the loop antenna to be configured as a resonant type, which enables high current generation even at low output power, thereby forming a high-density magnetic field. This configuration is effective even in medium-to long-range communication. In the series resonance circuit, the capacitor Cs sets the resonance frequency, and the series resistor Rs broadens the bandwidth. On the receiver side, stable signal reception may be ensured through the parallel resistor Rp and the LNA.

Embodiments of the present disclosure provide high efficiency and stability in medium-to long-range communication, offer the potential for maximizing power efficiency, and can deliver excellent performance beyond near-field communication technologies. Therefore, embodiments of the present disclosure may offer significant technical advancements in the design and implementation of resonant loop antenna-based medium-to long-range magnetic field communication systems.

The foregoing description has been provided for illustrative purposes only and is not intended to limit the scope of the invention. The invention encompasses not only the described embodiments but also design modifications or easily implementable alternatives. The invention also includes technologies that can be implemented by adapting the embodiments. Accordingly, the scope of the present invention should not be defined solely by the described embodiments, but rather by the claims and their equivalents.

Embodiments of the present disclosure may be implemented not only through the above-described devices and/or methods but also through a program that implements the corresponding functions of the components of the embodiment or a recording medium on which such a program is stored. Such implementations can be readily carried out by those skilled in the art based on the descriptions provided.

While exemplary embodiments have been described in detail above, the scope of the present disclosure is not limited thereto, and various modifications and improvements utilizing the basic concept of the disclosure by those skilled in the art also fall within the scope of the present disclosure.

What is claimed is:

1. A method for constructing a magnetic field communication system comprising a transmitting front end, a receiving front end, and a loop antenna, the method comprising:
defining system requirements including bandwidth, communication distance, and receiver sensitivity, and determining structural and material characteristics of the loop antenna including structure, size, and coil material;
calculating inductances and internal resistance values according to the number of turns of the loop antenna based on the structural and material characteristics;
calculating bandwidth values according to combinations of values of a series-connected resistance and the number of turns of the loop antenna based on the internal resistance values and inductances according to the number of turns of the loop antenna, wherein the series-connected resistance is comprised in the transmitting front end and is connected in series with the loop antenna;
generating a valid bandwidth matrix based on whether the calculated bandwidth values satisfy the defined system requirements;
calculating magnetic field density values at the communication distance based on combinations of the values of the series-connected resistance and the number of turns of the loop antenna;
generating a valid magnetic field density matrix based on whether the calculated magnetic field density values satisfy the defined system requirements including the receiver sensitivity;
determining the number of turns of the loop antenna and a value of the series-connected resistance based on the valid bandwidth matrix and the valid magnetic field density matrix; and
fabricating the loop antenna based on the determined number of turns and configuring the transmitting front end based on the determined value of the series-connected resistance.

2. The method of claim 1, wherein the defined system requirements further include a resonance frequency,
wherein the transmitting front end further includes a series-connected capacitor being connected in series with the series-connected resistance, and
wherein the method further comprises:
calculating capacitances of the series-connected capacitor according to the number of turns of the loop antenna so that the loop antenna resonates at the resonance frequency; and
calculating bandwidth values according to combinations of values of the series-connected resistance and the number of turns of the loop antenna is further based on the calculated capacitances.

3. The method of claim 1, wherein determining the number of turns of the loop antenna and the value of the series-connected resistance based on the valid bandwidth matrix and the valid magnetic field density matrix comprises:
multiplying the valid bandwidth matrix by the valid magnetic field density matrix; and
determining, based on a position (row m, column n) of an element having a value of 1 in the multiplication result matrix, the number of turns and the value of the series-connected resistance corresponding to the position (row m, column n).

4. The method of claim 1, wherein generating the valid bandwidth matrix comprises:
organizing the calculated bandwidth values into a first table according to combinations of the series-connected resistance and the number of turns of the loop antenna; and
generating the valid bandwidth matrix based on the first table by:
setting an element at a first position in the valid bandwidth matrix to 1 if a first bandwidth value at the first position in the first table satisfies the defined system requirements, and
setting an element at a second position in the valid bandwidth matrix to 0 if a second bandwidth value at the second position in the first table does not satisfy the defined system requirements; and
generating the valid magnetic field density matrix comprises:
organizing the calculated magnetic field density values at the communication distance into a second table according to combinations of the series-connected resistance and the number of turns of the loop antenna; and
generating the valid magnetic field density matrix based on the second table by:
setting an element at a third position in the valid magnetic field density matrix to 1 if a first magnetic field density value at the third position in the second table satisfies the defined system requirements, and
setting an element at a fourth position in the valid magnetic field density matrix to 0 if a second magnetic field density value at the fourth position in the second table does not satisfy the defined system requirements.

5. The method of claim 4, wherein, in generating the valid bandwidth matrix:
a determination that the first bandwidth value satisfies the defined system requirements is based on a determination that the first bandwidth value is greater than or equal to the bandwidth defined by the system requirements,
a determination that the second bandwidth value does not satisfy the defined system requirements is based on a determination that the second bandwidth value is less than the bandwidth defined by the system requirements, and
wherein, in generating the valid magnetic field density matrix:
a determination that the first magnetic field density value satisfies the defined system requirements is based on a determination that the first magnetic field density value is greater than or equal to the magnetic field density value corresponding to the receiver sensitivity defined by the system requirements, and
a determination that the second magnetic field density value does not satisfy the defined system requirements is based on a determination that the second magnetic field density value is less than the magnetic field density value corresponding to the receiver sensitivity defined by the system requirements.

6. The method of claim 1, wherein the receiving front end includes a parallel-connected resistance connected in parallel with the loop antenna,
the method further comprises,
calculating current values flowing through the receiving front end and values of the parallel-connected resistance according to the number of turns of the loop antenna so that a magnetic field density corresponding to the receiver sensitivity satisfies the defined system requirements, and
wherein the magnetic field density values at the communication distance are calculated based on the current values being calculated according to the number of turns of the loop antenna.

7. The method of claim 6, further comprising:
after determining the number of turns of the loop antenna based on the valid bandwidth matrix and the valid magnetic field density matrix, determining the value of the parallel-connected resistance based on the determined number of turns; and
configuring the receiving front end based on the determined value of the parallel-connected resistance.

8. The method of claim 1, wherein the number of rows and columns of the valid bandwidth matrix is the same as the number of rows and columns of the valid magnetic field density matrix.

9. The method of claim 1, further comprising testing the fabricated communication system and verifying whether the system satisfies the defined system requirements for the resonance frequency, bandwidth, communication distance, and receiver sensitivity.

10. A magnetic field communication system comprising:
a loop antenna;
a modem configured to generate a digital transmit signal;
a digital-to-analog converter configured to convert the digital transmit signal to an analog transmit signal;
a transmitting front end configured to deliver the analog transmit signal to the loop antenna and including a series-connected resistance connected in series with the loop antenna;
a receiving front end configured to receive an analog receive signal from the loop antenna; and
an analog-to-digital converter configured to convert the analog receive signal to a digital receive signal and deliver the digital receive signal to the modem,
wherein the number of turns of the loop antenna and the value of the series-connected resistance are determined based on a valid bandwidth matrix and a valid magnetic field density matrix,
wherein the valid bandwidth matrix is generated based on whether bandwidth values calculated from inductances and internal resistance values according to the number of turns of the loop antenna satisfy defined system requirements, and
wherein the valid magnetic field density matrix is generated based on whether magnetic field density values at communication distance calculated according to combinations of the series-connected resistance and the number of turns of the loop antenna satisfy the defined system requirements including receiver sensitivity.

11. The system of claim 10, wherein the defined system requirements further include a resonance frequency,
wherein the transmitting front end further includes a series-connected capacitor connected in series with the series-connected resistance,
wherein capacitances of the series-connected capacitor for allowing the loop antenna to resonate at the resonance frequency are calculated according to the number of turns of the loop antenna, and
wherein calculation of bandwidth values according to combinations of values of the series-connected resistance and the number of turns of the loop antenna is further based on the calculated capacitances.

12. The system of claim 10, wherein the value of the series-connected resistance is determined based on a position (row m, column n) where an element of a result matrix obtained by multiplying the valid bandwidth matrix by the valid magnetic field density matrix has a value of 1.

13. The system of claim 10, wherein, to generate the valid bandwidth matrix:
the calculated bandwidth values according to combinations of the series-connected resistance and the number of turns of the loop antenna are organized into a first table, and
the valid bandwidth matrix is generated based on the first table by:
setting an element at a first position in the valid bandwidth matrix to 1 if a first bandwidth value at the first position in the first table satisfies the defined system requirements, and
setting an element at a second position in the valid bandwidth matrix to 0 if a second bandwidth value at the second position in the first table does not satisfy the defined system requirements, and
wherein, to generate the valid magnetic field density matrix:
the calculated magnetic field density values at the communication distance are organized into a second table, and
the valid magnetic field density matrix is generated based on the second table by:
setting an element at a third position in the valid magnetic field density matrix to 1 if a first magnetic field density value at the third position in the second table satisfies the defined system requirements, and
setting an element at a fourth position in the valid magnetic field density matrix to 0 if a second magnetic field density value at the fourth position in the second table does not satisfy the defined system requirements.

14. The system of claim 13, a determination that the first bandwidth value satisfies the defined system requirements is based on a determination that the first bandwidth value is greater than or equal to the bandwidth defined by the system requirements,
a determination that the second bandwidth value does not satisfy the defined system requirements is based on a determination that the second bandwidth value is less than the bandwidth defined by the system requirements,
a determination that the first magnetic field density value satisfies the defined system requirements is based on a determination that the first magnetic field density value is greater than or equal to the magnetic field density value corresponding to the receiver sensitivity defined by the system requirements, and
a determination that the second magnetic field density value does not satisfy the defined system requirements is based on a determination that the second magnetic field density value is less than the magnetic field density value corresponding to the receiver sensitivity defined by the system requirements.

15. The system of claim 10, wherein the receiving front end includes a parallel-connected resistance connected in parallel with the loop antenna,
wherein current values flowing through the receiving front end and values of the parallel-connected resistance are calculated according to the number of turns of the loop antenna so that a magnetic field density corresponding to the receiver sensitivity satisfies the defined system requirements, and
wherein the magnetic field density values at the communication distance are calculated based on the current values calculated according to the number of turns of the loop antenna.

16. The system of claim 15, wherein after determining the number of turns of the loop antenna based on the valid bandwidth matrix and the valid magnetic field density matrix, the value of the parallel-connected resistance is determined based on the determined number of turns, and
wherein the receiving front end is configured based on the determined value of the parallel-connected resistance.

17. The system of claim 10, wherein the number of rows and columns of the valid bandwidth matrix is the same as the number of rows and columns of the valid magnetic field density matrix.
